(19) United States
(12) Patent Application Publication
(10) Pub. No.: US 2013/0248343 A1
(43) Pub. Date: Sep. 26, 2013

(54) MULTIDIRECTIONAL OPERATING SWITCH

(71) Applicant: PANASONIC CORPORATION, Osaka (JP)

(72) Inventors: Toshio TANAKA, Aichi (JP); Kenji OTOMO, Fukui (JP); Akira MIGIUMA, Fukui (JP)

(73) Assignee: PANASONIC CORPORATION, Osaka (JP)

(21) Appl. No.: 13/793,333

(22) Filed: Mar. 11, 2013

(30) Foreign Application Priority Data
Mar. 22, 2012 (JP) 2012-065000
Feb. 28, 2013 (JP) 2013-038390

(51) Int. Cl. H01H 21/02

(52) U.S. Cl. CPC H01H 21/025
USPC 200/6 A

(57) ABSTRACT

A multidirectional operating switch of the present invention includes a case having a substantially box shape and including a central cylindrical portion provided at substantially the center and a plurality of outer peripheral cylindrical portions provided at substantially equal angular intervals around the central cylindrical portion. The multidirectional operating switch includes an operation body held by the case so as to be pivotable in two or more directions and a wiring substrate arranged below the operation body. The multidirectional operating switch includes a switch contact provided on the wiring substrate of which electrical contact/separation is performed according to pivoting operation of the operation body and a light-emitting device mounted on the wiring substrate. A light through hole is provided on an upper surface of the central cylindrical portion and the light-emitting device is arranged below the central cylindrical portion.

### BACKGROUND

1. Technical Field

The present invention relates to a multidirectional operating switch used for operating various electronic devices mainly in an automobile.

2. Description of the Related Art

Recently, a so-called steering switch is mounted in proximity to a steering wheel on the automobile. It becomes popular to operate an electronic device such as an audio device and an air conditioner by operating the steering switch with a finger while holding a steering wheel. The steering switch, which enables multidirectional operation and illumination of a display at a lower cost, is required.

A conventional multidirectional operating switch used as the steering switch is described with reference to FIGS. 10 to 13.

FIG. 11 is a cross-sectional view of the conventional multidirectional operating switch and FIG. 12 is an exploded perspective view thereof. In FIGS. 11 and 12, a reference sign 1 represents an operation body formed of an insulating resin with substantially cylindrical operating unit 1A formed on an upper portion thereof. A pair of shaft hole portions 1B project from a lower surface of operating unit 1A. A plurality of display portions 1C, each of which is obtained by exposing a translucent portion having a shape of a character and a mark from its dark or silver light-blocking surroundings, are formed on an upper surface of operating unit 1A.

A reference sign 2 represents a case having a substantially box shape, shaft hole portions 1B of operation body 1 are supported by a pair of supporting portions 2A provided on an upper surface thereof and operation body 1 is held by case 2 so as to be pivotable forward and backward.

Further, at substantially the center of case 2, central cylindrical portion 2C projecting upward with inclining portion 2B formed around the same is formed. Inside hollow outer peripheral cylindrical portions 2D are formed a predetermined distance away from central cylindrical portion 2C outward in forward, backward, right and left directions.

Reference sign 3 represents a wiring substrate with a plurality of wiring patterns (not illustrated) formed on upper and lower surfaces thereof and a plurality of switch contacts 4 such as a push switch are mounted on the upper surface of wiring substrate 3.

A reference sign 5 represents a light-emitting device such as a light-emitting diode mounted in proximity to each switch contact 4 arranged below each of forward and backward outer peripheral cylindrical portions 2D of case 2. Light-emitting device 5 illuminates forward and backward two display portions 1C of operating unit 1A from below.

Further, a reference sign 6 represents a pressing body inserted into each of guide holes 2E provided so as to be opposed to each other in a direction orthogonal to both supporting portions 2A of case 2 so as to be movable upward and downward. An upper end of pressing body 6 abuts pressing portion 1D on a lower end of an outer periphery of operation body 1 and a lower end of pressing body 6 abuts a button portion of switch contact 4.

A reference sign 7 represents a cover with opening 7A formed on an upper surface thereof and operating unit 1A of operation body 1 projects from opening 7A upward. Cover 7 is fixed to case 2 by means of a screw (not illustrated) and the like to compose multidirectional operating switch 10.

FIG. 10 is a plan view of a steering. The steering includes steering wheel 11, pad 11A with a central air bag and the like embedded, and a spoke therebetween. Multidirectional operating switch 10 configured in the above-described manner is attached to spoke 11B on a right side, for example, with operating unit 1A of operation body 1 in front to be mounted on the automobile as illustrated in FIG. 10. Switch contact 4 and the like of multidirectional operating switch 10 is electrically connected to an electronic circuit (not illustrated) of a vehicle through a connecter, a lead wire (not illustrated) and the like.

In the above-described configuration, it is configured to press display portion 1C represented as “̂” on a front side of operating unit 1A and display portion 1C represented as “v” on a back side thereof by stretching a thumb while holding steering wheel 11. By being pressed, operation body 1 pivots forward and backward around shaft hole portion 1B, pressing portion 1D presses each of switch contacts 4 opposed to each other below the same through pressing body 6, and electrical contact/separation of switch contact 4 is performed. According to this, a sound volume of an audio device is turned up or off, for example, by the electronic circuit of the vehicle.

When a surrounding area is dark such as at night, a light switch (not illustrated) and the like separately mounted in proximity to steering wheel 11 is operated to allow a plurality of light-emitting devices 5 to emit light through the electronic circuit of the vehicle. Light of light-emitting device 5 passes through outer peripheral cylindrical portion 2D to illuminate display portion 1C of operating unit 1A above from below, so that operation body 1 may be easily identified or operated.

As illustrated in FIG. 10, multidirectional operating switch 10, which may be operated so as to pivot forward and backward in this manner, is mounted on a right side of the steering. On the other hand, multidirectional operating switch 20 for operating an air conditioner, for example, which may be operated so as to pivot in four directions: forward, backward, right and left, is mounted on a left side of the steering.

Operating unit 13A of multidirectional operating switch 20 has a substantially cylindrical outer shape as operating unit 1A of multidirectional operating switch 10 such that this may be easily operated with a thumb.

Herein, a schematic configuration of multidirectional operating switch 20 is described with reference to an exploded perspective view in FIG. 13.

In operation body 13, display portions 13C, each of which is formed of a translucent portion, are formed on an upper surface of substantially cylindrical operating unit 13A in four directions: forward, backward, right and left. Operation body 13 is fixed to substantially cylindrical pivoting body 14.

Pivoting body 14 is supported by inclining portion 2B on an outer periphery of central cylindrical portion 2C of case 2 so as to be pivotable in four directions: forward, backward, right and left.

A lower end portion of an outer periphery of pivoting body 14 abuts the upper end of pressing body 6 inserted into guide hole 2E of case 2. The lower end of pressing body 6 abuts the button portion of switch contact 4 mounted on an upper surface of wiring substrate 17. Electrical contact/separation of each of switch contacts 4 is performed according to pivoting operation of operation body 13 forward, backward, rightward, and leftward.

Further, four light-emitting devices 5 are arranged substantially immediately below display portions 13C, respectively. The light of light-emitting device 5 passes through outer peripheral cylindrical portion 2D and outer peripheral cylindrical portion 14A of pivoting body 14 above to illuminate display portion 13C from below.

A reference sign 16 represents a cover with opening 16A formed on an upper surface thereof and operating unit 13A of operation body 13 projects from opening 16A upward. Cover 16 is fixed to case 2 by means of a screw (not illustrated) and the like to compose multidirectional operating switch 20.

Meanwhile, such multidirectional operating switch 10 operated so as to pivot in the two directions and multidirectional operating switch 20 operated so as to pivot in the four directions use case 2 having a relatively complicated shape in common so as to realize a cost as low as possible.

Meanwhile, Unexamined Japanese Patent Publication No. 2011-96632 is known, for example, as a conventional art document related to the invention of this application.

### SUMMARY

Conventional multidirectional operating switch 10, which may be operated so as to pivot in two directions: forward and backward, uses case 2 in common with multidirectional operating switch 20 operated so as to pivot in four directions: forward, backward, right and left. Since light-emitting devices 5 are arranged immediately below display portions 1C, respectively, and in forward and backward directions below outer peripheral cylindrical portion 2D, there is a problem that it is difficult to realize a lower cost.

The present invention is achieved for solving such a conventional problem and this provides the multidirectional operating switch capable of surely illuminating at a lower cost.

In order to achieve the above-described object, a multidirectional operating switch of the present invention includes a case having a substantially box shape and including a central cylindrical portion provided at substantially the center and a plurality of outer peripheral cylindrical portions provided around the central cylindrical portion at substantially equal angular intervals. The multidirectional operating switch includes an operation body held by the case so as to be pivotable in two or more directions, and a wiring substrate arranged below the operation body. The multidirectional operating switch includes a switch contact in which electrical contact/separation is performed according to pivoting operation of the operation body, the switch contact provided on the wiring substrate, and a light-emitting device mounted on the wiring substrate. A light through hole is provided on an upper surface of the central cylindrical portion and the light-emitting device is arranged below the central cylindrical portion.

According to the present invention, it is not required to arrange the light-emitting device below each outer peripheral cylindrical portion opposed to the display portion of the operating unit, and it becomes possible that one light-emitting device illuminates a plurality of display portions above the same through light through holes. Therefore, the multidirectional operating switch capable of surely illuminating may be realized at a lower cost.

### BRIEF DESCRIPTION OF DRAWINGS

FIG. 1 is a cross-sectional view of a multidirectional operating switch according to a first embodiment of the present invention;

FIG. 2 is an exploded perspective view of the multidirectional operating switch according to the first embodiment of the present invention;

FIG. 3 is a cross-sectional view of another multidirectional operating switch, which uses a case of the multidirectional operating switch according to the first embodiment of the present invention in common;

FIG. 4 is an exploded perspective view of another multidirectional operating switch;

FIG. 5 is a cross-sectional view of a multidirectional operating switch according to a second embodiment of the present invention;

FIG. 6 is an exploded perspective view of the multidirectional operating switch according to the second embodiment of the present invention;

FIG. 7 is a cross-sectional view of a multidirectional operating switch according to a third embodiment of the present invention;

FIG. 8 is an exploded perspective view of the multidirectional operating switch according to the third embodiment of the present invention;

FIG. 9 is perspective view of a lower surface of a pivoting body of the multidirectional operating switch according to the third embodiment of the present invention;

FIG. 10 is a plan view of a conventional steering or a steering of the present invention;

FIG. 11 is a cross-sectional view of a conventional multidirectional operating switch;

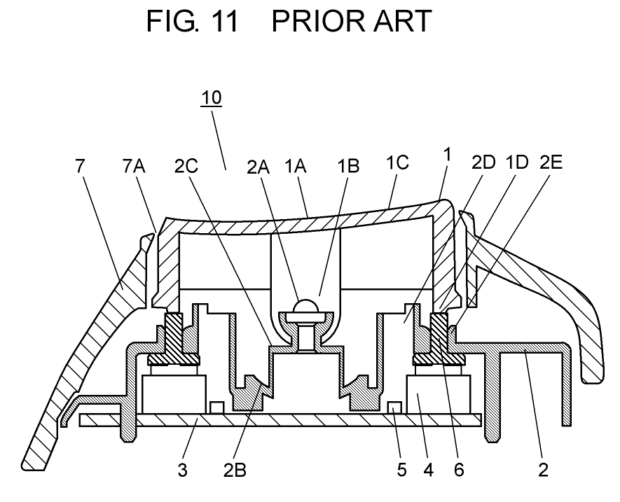

FIG. 12 is an exploded perspective view of the conventional multidirectional operating switch; and

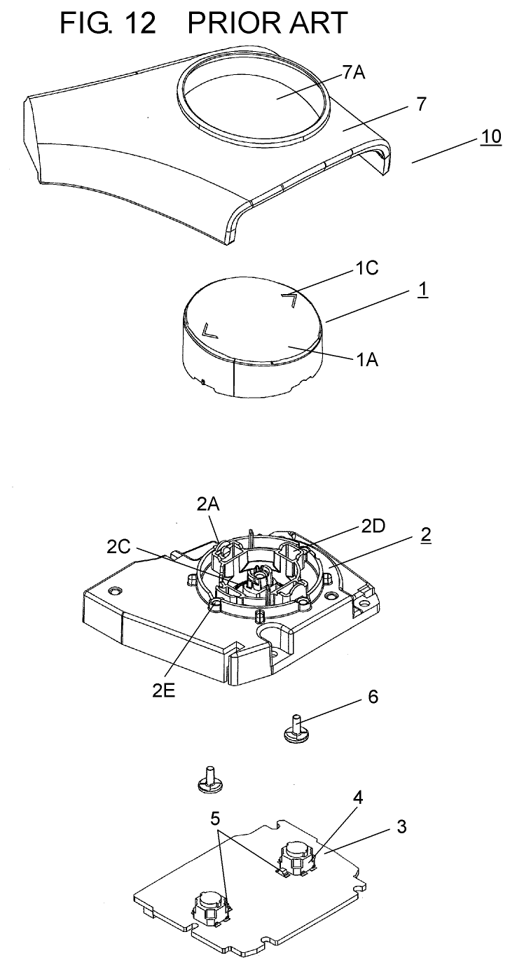

FIG. 13 is an exploded perspective view of another multidirectional operating switch, which uses a case of the conventional multidirectional operating switch in common.

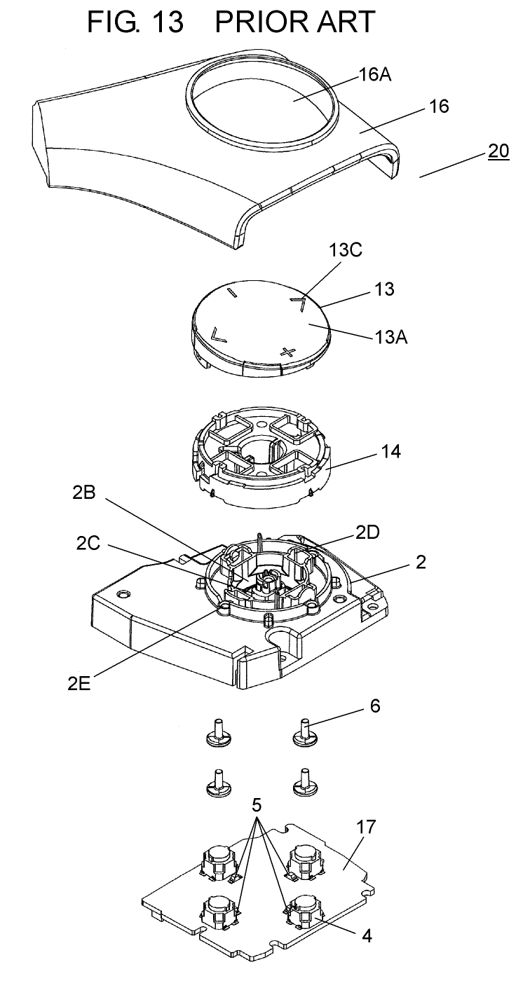

### DETAILED DESCRIPTION OF THE PREFERRED EMBODIMENTS

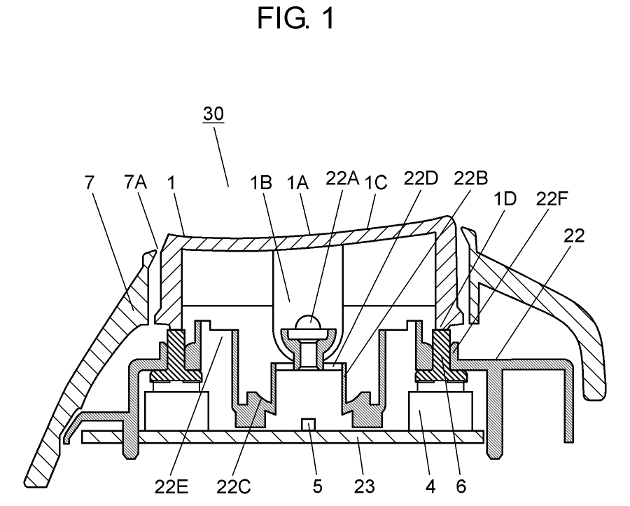

Embodiments of the present invention are hereinafter described with reference to FIGS. 1 to 10.

Meanwhile, the same reference sign is assigned to a portion having the same configuration as a configuration described in description of the related art and detailed description thereof is omitted.

### First Exemplary Embodiment

A first embodiment of a multidirectional operating switch of the present invention is described with reference to the drawings.

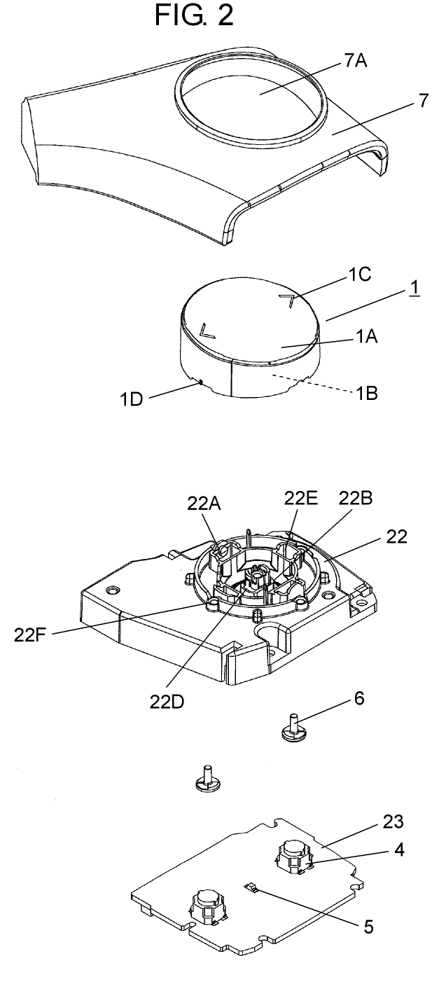

FIG. 1 is a cross-sectional view of the multidirectional operating switch of this embodiment and FIG. 2 is an exploded perspective view of the multidirectional operating switch of this embodiment. In FIGS. 1 and 2, a reference sign 1 represents an operation body formed of an insulating resin such as polycarbonate and acrylonitrile-butadiene-styrene copolymer (hereinafter, referred to as ABS) and the like with a substantially cylindrical operating unit 1A formed on an upper portion thereof. A pair of shaft hole portions 1B projects from a lower surface of operating unit 1A.

A plurality of display portions 1C, each of which is obtained by exposing a translucent portion having a shape of a character, a mark and the like from its dark or silver light-blocking surroundings, are formed on an upper surface of operating unit 1A. The translucent portion is formed by two-color formation, laser processing and the like.

A reference sign 22 represents a case formed of an insulating resin such as polyoxymethylene (hereinafter, referred to as POM) and polybutylene terephthalate into a substantially box shape. A pair of supporting portions 22A is provided on an upper surface of case 22, shaft hole portion 1B of operation body 1 is supported by an inwardly projecting portion of supporting portion 22A, and operation body 1 is held by case 22 so as to be pivotable forward and backward.

Further, a reference sign 22B represents a central cylindrical portion located at substantially the center of case 22 so as to project upward. Inclining portion 22C located around an outer periphery of central cylindrical portion 22B so as to incline downward from an outer side inward into a substantially cup shape is formed in case 22. In case 22, light through holes 22D are provided on a front side and a back side of an upper surface of central cylindrical portion 22B.

Also, in case 22, a plurality of inside hollow outer peripheral cylindrical portions 22E located a predetermined distance away from central cylindrical portion 22B outward in forward, backward, right and left directions are formed.

A reference sign 23 represents a wiring substrate formed of an insulating resin such as paper phenol and epoxy with glass with a plurality of wiring patterns (not illustrated) formed on upper and lower surfaces thereof. A plurality of switch contacts 4 such as a push switch are mounted on the upper surface of wiring substrate 23.

Also, a reference sign 5 represents a light-emitting device such as a light-emitting diode mounted at substantially the center of a space below central cylindrical portion 22B of case 22.

Further, a reference sign 6 represents a pressing body inserted into each of guide holes 22F provided so as to be opposed to each other in a direction orthogonal to both supporting portions 22A of case 22 so as to be movable upward and downward. An upper end of pressing body 6 abuts pressing portion 1D on a lower end of an outer periphery of operation body 1 and a lower end of pressing body 6 abuts a button portion of switch contact 4, respectively.

A reference sign 7 represents a cover with opening 7A formed on an upper surface thereof and operating unit 1A of operation body 1 projects from opening 7A upward. Cover 7 is fixed to case 22 by means of a screw (not illustrated) and the like to compose multidirectional operating switch 30.

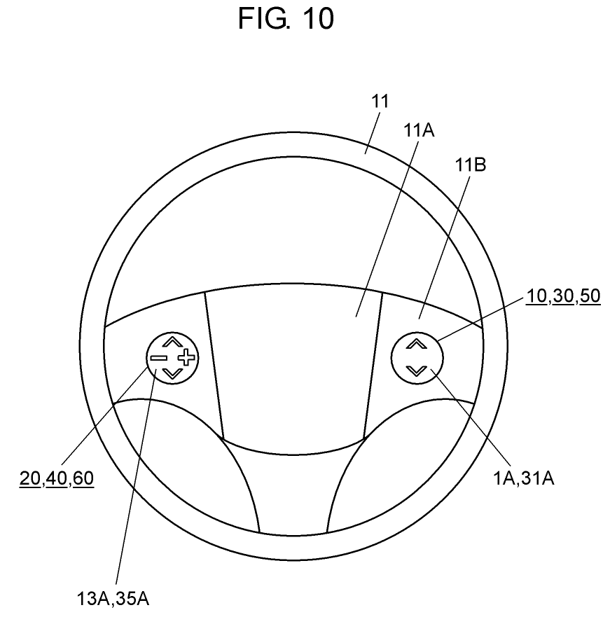

Multidirectional operating switch 30 configured in this manner is attached to spoke 11B on a right side, for example, with operating unit 1A of operation body 1 in front to be mounted on an automobile as illustrated in FIG. 10. Further, switch contact 4 and the like of multidirectional operating switch 30 is electrically connected to an electronic circuit (not illustrated) of a vehicle through a connecter, a lead wire (not illustrated) and the like.

In the above-described configuration, it is configured to press display portion 1C represented as “̂” on a front side of operating unit 1A and display portion 1C represented as “v” on a back side thereof by stretching a thumb while holding steering wheel 11. When being pressed, operation body 1 pivots forward and backward around shaft hole portion 1B and pressing portion 1D presses each of switch contacts 4 opposed to each other below the same through pressing body 6, thereby allowing electrical contact/separation of switch contact 4. According to this, the electronic circuit of the vehicle turns up or down a sound volume of an audio device, for example.

When a surrounding area is dark such as at night, a light switch (not illustrated) and the like separately mounted in proximity to steering wheel 11 is operated to allow light-emitting device 5 to emit light through the electronic circuit of the vehicle. Light of light-emitting device 5 passes through light through holes 22D on front and back sides of central cylindrical portion 22B to illuminate display portions 1C in the proximity of both forward and backward ends of operating unit 1A above from below, so that operation body 1 may be easily identified or operated.

As illustrated in FIG. 10, such multidirectional operating switch 30, which may be operated so as to pivot forward and backward, is mounted on a right side of a steering. On the other hand, multidirectional operating switch 40 for operating an air conditioner, for example, which may be operated so as to pivot in four directions: forward, backward, right and left, is mounted on a left side of the steering.

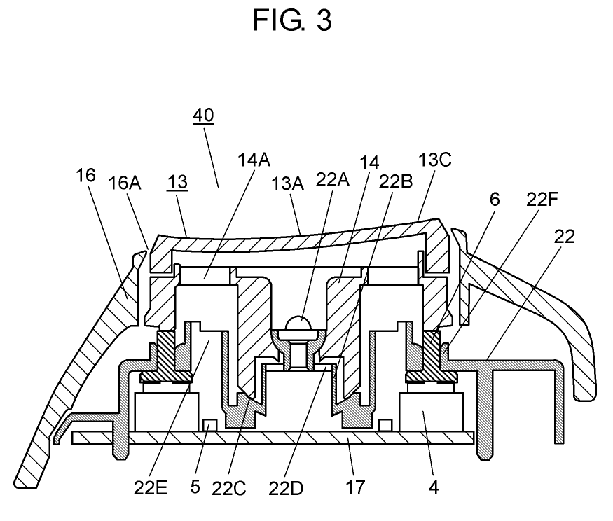

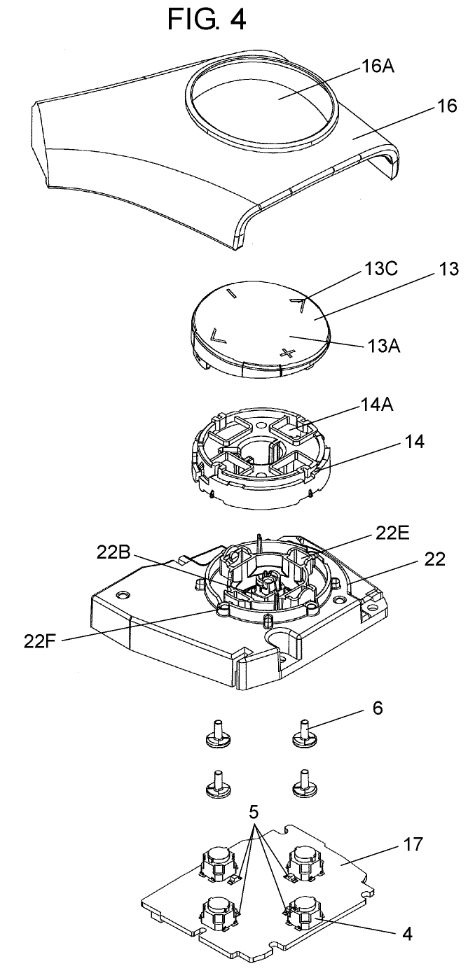

A schematic configuration of multidirectional operating switch 40 is herein described with reference to a cross-sectional view in FIG. 3 and an exploded perspective view in FIG. 4.

In operation body 13, display portions 13C, each of which is formed of a translucent portion, are formed on an upper surface of substantially cylindrical operating unit 13A in four directions: forward, backward, right and left. Operation body 13 is fixed to substantially cylindrical pivoting body 14.

Pivoting body 14 is supported by inclining portion 22C on an outer periphery of central cylindrical portion 22B of case 22 so as to be pivotable in four directions: forward, backward, right and left.

Operating unit 13A of multidirectional operating switch 40 has a substantially cylindrical outer shape as that of operating unit 1A of multidirectional operating switch 30 such that this may be easily operated with a thumb.

A lower end portion of an outer periphery of pivoting body 14 abuts the upper end of pressing body 6 inserted into guide hole 22F of case 22. The lower end of pressing body 6 abuts the button portion of switch contact 4 mounted on an upper surface of wiring substrate 17. Electrical contact/separation of each of switch contacts 4 is performed according to pivoting operation of operation body 13 forward, backward, rightward, and leftward.

Also, four light-emitting devices 5 are arranged substantially immediately below display portions 13C, respectively. The light of light-emitting device 5 passes through outer peripheral cylindrical portion 22E and outer peripheral cylindrical portion 14A of pivoting body 14 above to illuminate display portion 13C from below.

Meanwhile, multidirectional operating switch 30 operated so as to pivot in the two directions and multidirectional operating switch 40 operated so as to pivot in the four directions described above have case 22 having a relatively complicated shape in common.

That is to say, in multidirectional operating switch 40, light-emitting devices 5 are arranged on wiring substrate 17 below outer peripheral cylindrical portions 22E formed on front, back, right, and left sides of case 22. However, multidirectional operating switch 30 is provided with forward and backward light through holes 22D on the upper surface of central cylindrical portion 22B. Therefore, one light-emitting device 5 arranged below central cylindrical portion 22B illuminates two display portions 1C above the same through light through holes 22D. According to this, the number of light-emitting devices 5 to be arranged is decreased.

In this manner, according to this embodiment, light through holes 22D are arranged on the upper surface of central cylindrical portion 22B of case 22 in two directions: forward and backward, so that it is not required to arrange light-emitting device 5 below each outer peripheral cylindrical portion 22E so as to be opposed to display portion 1C of operating unit 1A. According to this, it becomes possible that one light-emitting device 5 illuminates a plurality of display portions 1C above the same through light through holes 22D. As a result, the multidirectional operating switch with a simple configuration capable of surely illuminating may be realized at a lower cost.

Meanwhile, the multidirectional operating switch capable of being operated so as to pivot forward and backward is described above. However, it is also possible that the operating unit with the display portions formed on right and left sides is pivotably supported by the case and that openings are provided on the upper surface of the central cylindrical portion of the case on right and left sides. In this case also, it is possible to arrange one light-emitting device below the central cylindrical portion to illuminate upward.

Although a configuration using a single push switch as switch contact 4 is described, it is also possible to form a fixed contact of carbon and the like on the upper surface of wiring substrate 23 and put a movable contact formed of a conducting metal thin plate having a substantially dome shape above the same. Alternatively, it is also possible to use various switch contacts such as a switch contact obtained by using a flexible rubber contact having a substantially dome shape with the movable contact formed on a lower surface thereof.

### Second Exemplary Embodiment

A second embodiment of a multidirectional operating switch of the present invention is described with reference to the drawings.

Meanwhile, the same reference sign is assigned to a portion having the same configuration as a configuration of the first embodiment and detailed description thereof is omitted.

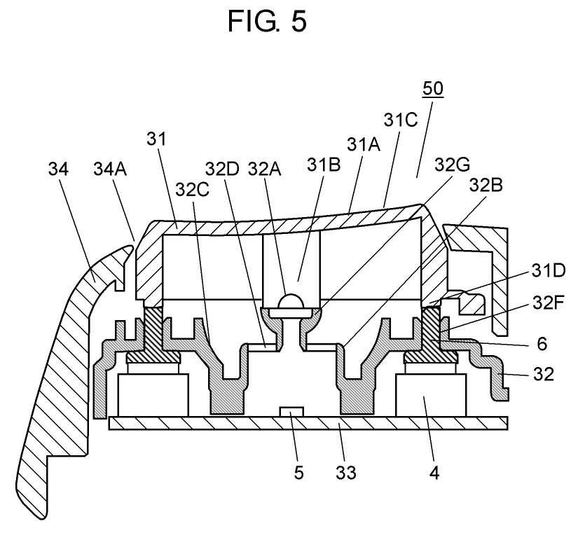

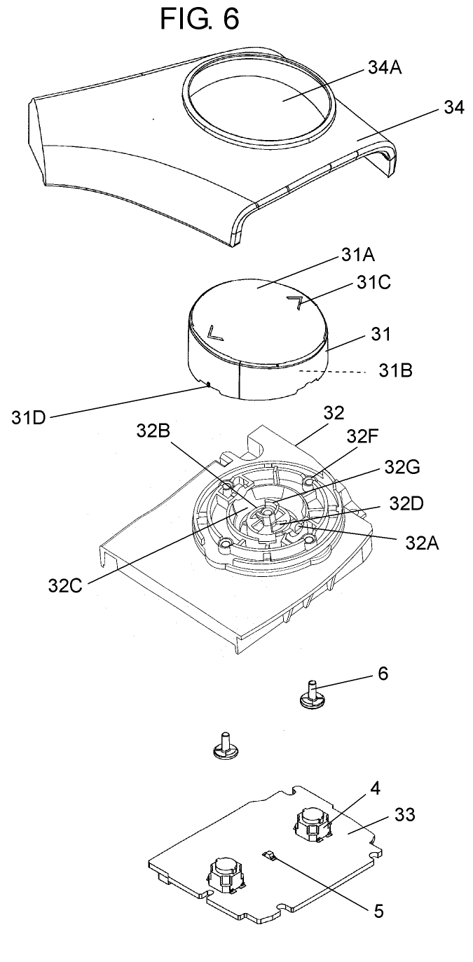

FIG. 5 is a cross-sectional view of the multidirectional operating switch operated so as to pivot in two directions according to this embodiment and FIG. 6 is an exploded perspective view of the multidirectional operating switch of this embodiment. In FIGS. 5 and 6, a reference sign 31 represents an operation body with display portions 31C, each of which is formed of a translucent portion, formed on an upper surface of substantially cylindrical operating unit 31A in two directions: forward and backward. A pair of shaft hole portions 31B projects from a lower surface of operating unit 31A.

A reference sign 32 represents a case formed of an insulating resin into a substantially box shape. Substantially cylindrical central cylindrical portion 32B projecting upward is provided at substantially the center of an upper surface of case 32.

Further, flanged retaining portion 32G extending upward and outward is provided at the center of an upper surface of central cylindrical portion 32B. Four light through holes 32D having a substantially fan shape opening are provided on the upper surface of central cylindrical portion 32B and around retaining portion 32G in four directions: forward, backward, right and left.

Also, a pair of supporting portions 32A having a substantially shaft shape projecting outward is provided so as to be opposed to each other on the right and on the left across central cylindrical portion 32B on the upper surface of case 32. Inclining portion 32C arranged on substantially the same radius around an axis of central cylindrical portion 32B is provided around central cylindrical portion 32B. Inclining portion 32C has a concave shape inclined downward from an outside inward on front, back, right, and left sides into a substantially cup shape.

Shaft hole portion 31B of operation body 31 is supported by supporting portion 32A of case 32 and operation body 31 is held by case 32 so as to be pivotable in two directions: forward and backward. This is similar to that in the first embodiment.

A plurality of switch contacts 4 such as a push switch are mounted in predetermined positions on an upper surface of wiring substrate 33. One light-emitting device 5 is mounted on the upper surface of wiring substrate 33 and at substantially the center below central cylindrical portion 32B of case 32. This also is similar to that in the first embodiment.

Further, pressing body 6 is inserted in each of forward and backward guide holes 32F of case 32 so as to be movable upward and downward. An upper end of pressing body 6 abuts pressing portion 31D of operation body 31 and a lower end of pressing body 6 abuts a button portion of switch contact 4. Along with pivoting operation of operation body 31 forward and backward, electrical contact/separation of forward and backward switch contacts 4 is performed. This also is similar to that in the first embodiment.

Operating unit 31A of operation body 31 projects from opening 34A on an upper surface of cover 34 upward. Cover 34 is fixed to case 32 by means of a screw and the like to compose multidirectional operating switch 50.

Multidirectional operating switch 50 configured in this manner is mounted on predetermined spoke 11B of a steering as illustrated in FIG. 10. When any of display portions 31C on front and back sides of operating unit 31A is pressed, operation body 31 pivots forward and backward. Pressing portion 31D presses switch contact 4 below the same through pressing body 6 to perform electrical contact/separation of switch contact 4, and desired operation of an electronic device in a vehicle is performed. This also is similar to that in the first embodiment.

When a surrounding area is dark such as at night, light-emitting device 5 is allowed to emit light by predetermined operation. Light of light-emitting device 5 passes through light through holes 32D on front and back sides of central cylindrical portion 32B to illuminate display portions 31C in the proximity of forward and backward both ends of operating unit 31A above from below, so that operation body 31 may be easily identified or operated.

In this manner, a pair of supporting portions 32A opposed to each other across substantially cylindrical central cylindrical portion 32B of case 32 is provided in this embodiment. Inclining portion 32C inclined into a substantially cup shape on front, back, right, and left sides around central cylindrical portion 32B is provided around central cylindrical portion 32B. Light through holes 32D are provided on the upper surface of central cylindrical portion 32B in four directions: forward, backward, right and left. One light-emitting device 5 is arranged below central cylindrical portion 32B. Operation body 31 is pivotably held by supporting portion 32A. Therefore, it is not required to arrange light-emitting device 5 below each display portion 31C of operating unit 31A so as to oppose to each other. According to this, it becomes possible that one light-emitting device 5 illuminates a plurality of display portions 31C above the same through light through holes 32D. As a result, the multidirectional operating switch with a simple configuration capable of surely illuminating may be realized at a lower cost.

### Third Exemplary Embodiment

A third embodiment of the present invention is described with reference to the drawings.

Meanwhile, the same reference sign is assigned to a portion having the same configuration as a configuration of the first and second embodiments and detailed description thereof is omitted.

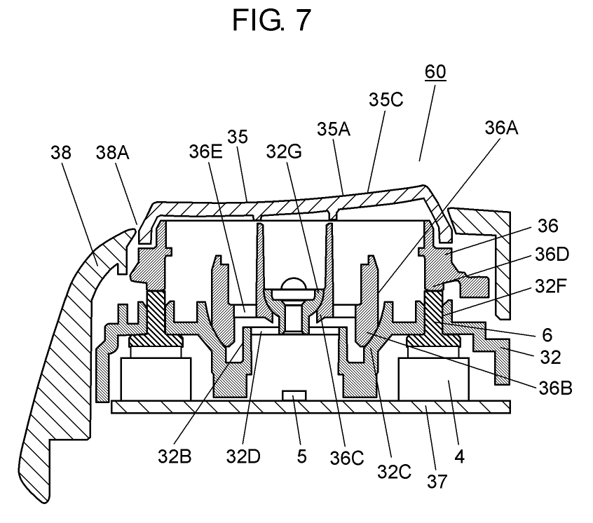

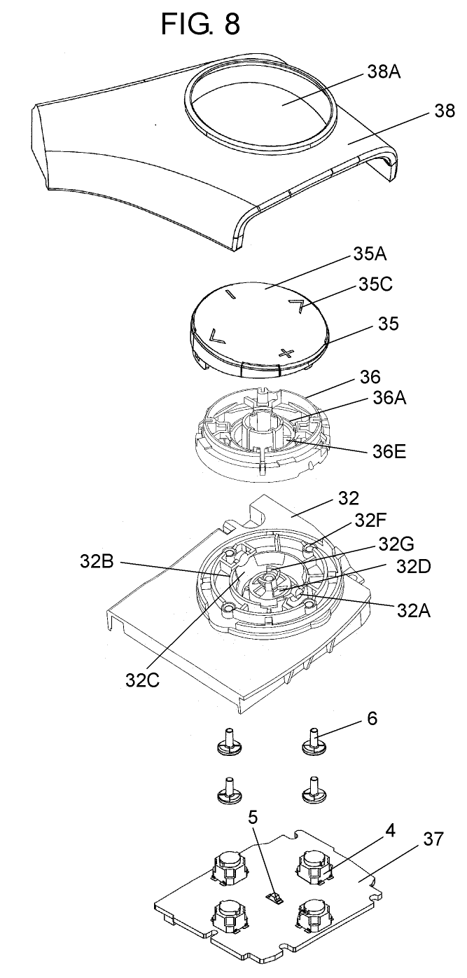

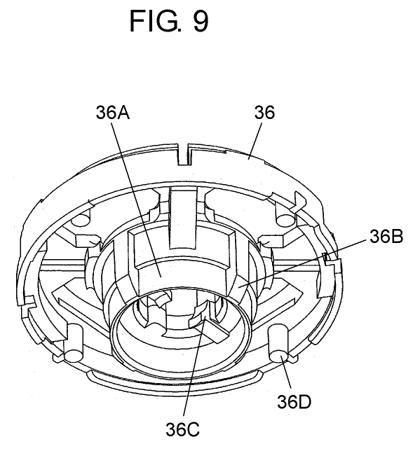

FIG. 7 is a cross-sectional view of a multidirectional operating switch operated so as to pivot in four directions according to this embodiment and FIG. 8 is an exploded perspective view of the multidirectional operating switch of this embodiment. FIG. 9 is a perspective view of a lower surface of a pivoting body of the multidirectional operating switch of this embodiment. In FIGS. 7 and 8, a reference sign 35 represents an operation body with display portions 35C, each of which is formed of a translucent portion, formed on an upper surface of substantially cylindrical operating unit 35A in four directions: forward, backward, right and left. Operation body 35 is fixed to substantially cylindrical pivoting body 36.

Meanwhile, pivoting body 36 is formed of an insulating resin such as ABS and POM.

As illustrated in FIG. 9, a substantially cylindrical supporting cylindrical portion 36A with an opening on an upper surface thereof is provided at the center of a lower surface of pivoting body 36. A convex pivot supporting portion 36B of which lower end portion substantially curves downward from an outer side inward is formed on an outer periphery of supporting cylindrical portion 36A.

Also, a pair of engaging portions 36C opposed to each other in a direction of the center of supporting cylindrical portion 36A, of which surface facing the center of supporting cylindrical portion 36A has a substantially curved concave shape, is formed on an inner side of supporting cylindrical portion 36A.

Further, four light through portions 36E, which are openings, are formed around engaging portion 36C and between engaging portion 36C and supporting cylindrical portion 36A in four directions: forward, backward, right and left.

Pivoting body 36 is held by each of inclining portions 32C of case 32 opposed to pivot supporting portions 36B on the lower surface of pivoting body 36 on front, back, right, and left sides, respectively, so as to be slidable forward, backward, rightward, and leftward. Engaging portion 36C on an inner side of pivoting body 36 is arranged so as to be overlapped with a lower portion of retaining portion 32G of case 32 in a vertical direction and pivoting body 36 is prevented from dropping out from case 32.

A reference sign 37 represents a wiring substrate formed of an insulating resin with a plurality of wiring patterns formed on upper and lower surfaces thereof. A plurality of switch contacts 4 are mounted in predetermined positions on the upper surface of wiring substrate 37. This is similar to that in the first and second embodiments.

Pressing body 6 is inserted into each of guide holes 32F provided in four directions: forward, backward, right and left, on the same radius from the center of central cylindrical portion 32B of case 32 so as to be movable upward and downward. An upper end of pressing body 6 abuts pressing portion 36D on a lower surface in the proximity of an outer periphery of pivoting body 36 and a lower end of pressing body 6 abuts a button portion of switch contact 4. This also is similar to that in the first and second embodiments.

Operating unit 35A of operation body 35 projects from opening 38A of cover 38 upward. Cover 38 is fixed to case 32 by means of a screw and the like to compose multidirectional operating switch 60.

Multidirectional operating switch 60 configured in this manner is mounted on a predetermined spoke of a steering to be electrically connected to an electronic circuit of a vehicle as illustrated in FIG. 10. This also is similar to that in the first and second embodiments.

In the above-described configuration, it is configured to press each display portion 35C of operating unit 35A by stretching a thumb while holding steering wheel 11. When being pressed, pivoting body 36 fixed to operation body 35 pivots in a pressing direction in a state in which pivot supporting portion 36B is slidingly held by an upper surface of inclining portion 32C of case 32 and pressing portion 36D presses each of switch contacts 4 opposed to each other below the same through pressing body 6, so that electrical contact/separation of switch contact 4 is performed. According to this, a sound volume of an audio device is turned up or down or an audio mode is switched, for example, by the electronic circuit of the vehicle.

When a surrounding area is dark such as at night, light-emitting device 5 is allowed to emit light by predetermined operation. Light of light-emitting device 5 passes through light through holes 32D on an upper surface of central cylindrical portion 32B on front, back, right, and left sides and light through portion 36E of pivoting body 36. According to this, the light of light-emitting device 5 illuminates display portions 35C in the proximity of forward, backward, right and left ends of operating unit 35A above from below, so that operation body 35 may be easily identified and operated. In this embodiment, light through holes 32D are provided around retaining portion 32G of case 32 in four directions: forward, backward, right and left.

That is to say, the light from one light-emitting device 5 arranged below central cylindrical portion 32B may pass through light through hole 32D of case 32 and light through portion 36E of pivoting body 36 to illuminate a lower surface of corresponding display portion 35C of operation body 35.

In this manner, according to this embodiment, in case 32 in which operation body 35 is pivotably held by pivoting body 36, light through holes 32D are provided on the upper surface of central cylindrical portion 32B provided at substantially the center of case 32 in four directions: forward, backward, right and left. One light-emitting device 5 is arranged below central cylindrical portion 32B. Therefore, it is not required to illuminate each display portion 35C by arranging four light-emitting devices 5 below four display portions 35C of operating unit 35A so as to correspond thereto. According to this, it becomes possible that one light-emitting device 5 illuminates four display portions 35C through light through holes 32D. As a result, the multidirectional operating switch with a simple configuration capable of surely illuminating may be realized at a lower cost.

Meanwhile, multidirectional operating switch 60 including operation body 35 pivotable in four directions is described as an example in the description above. However, a three-directional operating switch in which the operation body is pivotable rightward or leftward in addition to two directions: forward and backward, is also possible. Also, a three-directional operating switch in which the operation body is pivotable in three directions at the same angle is also possible. Alternatively, the present invention may be carried out for various multidirectional operating switches in which the operation body pivots in five or more directions.

Also, case 32 is provided with a pair of supporting portions 32A opposed to each other across central cylindrical portion 32B. Inclining portion 32C inclined into a substantially cup shape around central cylindrical portion 32B is provided in proximity to an outer periphery of central cylindrical portion 32B. As described in the second embodiment, it is possible to realize multidirectional operating switch 50, which may be operated so as to pivot in two directions, by allowing operation body 31 to be held by supporting portion 32A so as to be pivotable in two directions. Alternatively, as described in the third embodiment, it is possible to realize multidirectional operating switch 60, which may be operated so as to pivot in four directions, by holding pivoting body 36 to which operation body 35 is fixed by inclining portion 32C so as to be pivotable in four directions: forward, backward, right and left. Case 32 having a complicated shape may be commonly used by multidirectional operating switches pivotable in two or three or more directions. Therefore, it is possible to obtain the multidirectional operating switch, of which shaping mold may be used in common, excellent in productivity at a lower cost.

The multidirectional operating switch according to the present invention may surely illuminate with a simple configuration at a lower cost and is useful for operating various electronic devices mainly of an automobile.

What is claimed is:

1. A multidirectional operating switch, comprising:
a case having a substantially box shape and including a central cylindrical portion provided at a substantially center;
an operation body held by the case so as to be pivotable in two or more directions;
a wiring substrate arranged below the operation body;
a switch contact in which electrical contact/separation is performed according to pivoting operation of the operation body, the switch contact provided on the wiring substrate; and
a light-emitting device mounted on the wiring substrate, wherein
a light through hole is provided on an upper surface of the central cylindrical portion, and
the light-emitting device is arranged below the central cylindrical portion.

2. The multidirectional operating switch according to claim 1, wherein light through holes each identical to the light through hole are provided on the upper surface of the central cylindrical portion in the two or more directions.

3. The multidirectional operating switch according to claim 1, wherein the case further includes a pair of supporting portions opposed to each other across the central cylindrical portion and an inclining portion inclined into a substantially cup shape around the central cylindrical portion in proximity to an outer periphery of the central cylindrical portion, and
the operation body is held by the supporting portions so as to be pivotable in two directions.

4. The multidirectional operating switch according to claim 2, wherein the case further includes a pair of supporting portions opposed to each other across the central cylindrical portion and an inclining portion inclined into a substantially cup shape around the central cylindrical portion in proximity to an outer periphery of the central cylindrical portion, and
the operation body is held by the supporting portions so as to be pivotable in two directions.

5. The multidirectional operating switch according to claim 1, wherein
the case further includes a pair of supporting portions opposed to each other across the central cylindrical portion and an inclining portion inclined into a substantially cup shape around the central cylindrical portion in proximity to an outer periphery of the central cylindrical portion,
a pivoting body fixed to the operation body is further provided between the operation body and the case, and
the operation body is held by the inclining portion so as to be pivotable in three or more directions by the pivoting body.

6. The multidirectional operating switch according to claim 2, wherein
the case further includes a pair of supporting portions opposed to each other across the central cylindrical portion and an inclining portion inclined into a substantially cup shape around the central cylindrical portion in proximity to an outer periphery of the central cylindrical portion,
a pivoting body fixed to the operation body is further provided between the operation body and the case, and
the operation body is held by the inclining portion so as to be pivotable in three or more directions by the pivoting body.
